(19) United States
(12) Patent Application Publication
(10) Pub. No.: US 2018/0129653 A1
(43) Pub. Date: May 10, 2018

(54) PREVIEW METHOD AND APPARATUS FOR SEARCHING FOR PICTURES BY MOBILE TERMINAL

(71) Applicant: BEIJING QIHOO TECHNOLOGY COMPANY LIMITED, Beijing (CN)

(72) Inventors: Yanli WANG, Beijing (CN); Kai WU, Beijing (CN)

(21) Appl. No.: 15/563,946

(22) PCT Filed: Mar. 31, 2016
(86) PCT No.: PCT/CN2016/078053

§ 371 Date: Oct. 2, 2017

(30) Foreign Application Priority Data
Apr. 2, 2015 (CN) 201510155664.X

(51) Int. Cl. G06F 17/30; G06F 3/0484

(52) U.S. Cl. CPC G06F 17/30002; G06F 17/30277; G06F 3/04847; G06F 3/04842; G06F 17/3089

(57) ABSTRACT

Provided are a preview method and apparatus for searching for pictures by a mobile terminal. The method comprises: receiving a search request submitted by a user on a mobile search client; acquiring a search result of a plurality of thumbnail pictures that matches the search request and comprises corresponding detail pages, and displaying the plurality of thumbnail pictures; receiving an access operation of the user for a certain thumbnail picture, and extracting an enlarged picture for the thumbnail picture; and creating a first page floating layer for displaying the enlarged picture, and enabling the first page floating layer to cover a current page of the mobile search client. According to the present invention, a user may directly select and view a picture that meets search demands of the user on a search result page, and may directly preview pictures in a detail page on the current interface.

### CROSS-REFERENCE TO RELATED APPLICATIONS

This application is the national stage of International application Ser. No. PCT/CN2016/078053 filed Mar. 31, 2016, which claims the benefit of Chinese Patent Application No. CN201510155664.X filed Apr. 2, 2015, the entity of which are incorporated herein by reference.

### FIELD OF TECHNOLOGY

The present invention relates to the field of mobile terminal technologies, and more particularly, to a preview method for searching for pictures by a mobile terminal, and a preview apparatus for searching for pictures by a mobile terminal.

### BACKGROUND

Various search products on mobile terminals perform searching according to news keywords inputted by users, and titles, text summaries and sites of search results are supplied for the users to view on search result pages. The titles or the text summaries need to be linked to detail pages of the search results, and the users may view specific contents of the detail pages by clicking the titles or the summaries.

For news including a single picture or multiple pictures, the picture demand features of such news are relatively obvious, and the users prefer to view pictures therein. However, by employing a current search result display mode, the users cannot view whether there are pictures in the detail pages from the search result pages and also cannot know whether the pictures in the detail pages are related to the news keywords. In addition, the effect is caused not to be intuitive since long paragraphs are filled in the search results while screens of the mobile terminals are limited. In general, the user enters the detail pages through a clicking operation to view pictures including drawings and texts in a combination manner and arranged in the form of waterfall stream. The search result pages are returned to continue to view other search results if the pictures therein are unrelated to the news keywords searched by the users. Operation steps and time on the pages are increased for the users because of viewing for many times. Meanwhile, loads of clients and servers are also increased by requesting pages for many times.

### SUMMARY

In view of the above problems, the present invention is proposed to provide a preview method for searching for pictures by a mobile terminal and a preview apparatus for searching for pictures by a mobile terminal to overcome or at least partially solve the above problems.

According to an aspect of the present invention, there is provided a preview method for searching for pictures by a mobile terminal, comprising: receiving a search request submitted by a user on a mobile search client; acquiring a search result of a plurality of thumbnail pictures that matches the search request and comprises corresponding detail pages, and displaying the plurality of thumbnail pictures; receiving an access operation of the user for a certain thumbnail picture, and extracting an enlarged picture for the thumbnail picture; and creating a first page floating layer for displaying the enlarged picture, and enabling the first page floating layer to cover a current page of the mobile search client.

According to another aspect of the present invention, there is provided a preview apparatus for searching for pictures by a mobile terminal, comprising: a search request receiving module, configured to receive a search request submitted by a user on a mobile search client; a thumbnail picture display module, configured to acquire a search result of a plurality of thumbnail pictures that matches the search request and comprises corresponding detail pages, and display the plurality of thumbnail pictures; a picture access receiving module, configured to receive an access operation of the user for a certain thumbnail picture, and extract an enlarged picture for the thumbnail picture; and a first enlarged picture display module, configured to create a first page floating layer for displaying the enlarged picture, and enable the first page floating layer to cover a current page of the mobile search client.

According to embodiments of the present invention, after receiving a search request submitted by a user on a mobile search client, a search result is acquired according to the search request, and thumbnail pictures of detail pages comprised in the search result are displayed. The user may directly see whether there is a picture in the search result from a search result page, and may determine whether the picture is related to the search request. In this way, the user may select to view a picture meeting the user's searching requirements. Further, after receiving an access operation of the user for a certain thumbnail picture, a detail page corresponding to the search result is not displayed. Instead, a first page floating layer is created on the mobile search client to display the enlarged picture corresponding to the thumbnail picture, so that the user directly previews, on a current interface, pictures in the detail page. In this way, visual experience of the user for the search result is improved, user adhesiveness to a mobile search client is enhanced, operations for requesting pages from a server are reduced because it is unnecessary to display the corresponding detail page, traffic consumption of the mobile client is reduced, and loads on the mobile client and the server are reduced.

In the embodiment of the present invention, the enlarged picture may be displayed in full screen, which may be larger than a picture displayed in the detail page, thereby facilitating the user to view the picture and improving a visual effect of the picture.

In the embodiment of the present invention, after a thumbnail picture therein is accessed, a link address of an adjacent enlarged picture may be extracted in advance and stored in a mobile search client. The user may locally extract the link address to directly acquire the picture when the user needs to view a next picture. Compared with a scheme for temporarily extracting the link address, the picture can be more rapidly displayed.

Described above is merely an overview of the technical solution of the present invention. In order to more apparently understand the technical means of the present invention to implement in accordance with the contents of specification, and to more readily understand above and other objectives, features and advantages of the present invention, specific embodiments of the present invention are provided hereinafter.

### BRIEF DESCRIPTION OF THE DRAWINGS

Through reading the detailed description of the following preferred embodiments, various other advantages and benefits will become apparent to an ordinary person skilled in the art. Accompanying drawings are merely included for the purpose of illustrating the preferred embodiments and should not be considered as limiting of the present invention. Further, throughout the drawings, same elements are indicated by same reference numbers. In the drawings:

FIG. 1 is a flowchart of steps of a preview method for searching for pictures by a mobile terminal according to Embodiment I of the present invention;

FIG. 2 is a flowchart of steps of a preview method for searching for pictures by a mobile terminal according to Embodiment II of the present invention;

FIG. 3a is a schematic diagram of a search result in the background art;

FIG. 3b is a detail page for corresponding display of search in the background art;

FIG. 3c is a schematic diagram of a search result page according to an embodiment of the present invention;

FIG. 3d is a schematic diagram of viewing an enlarged picture according to an embodiment of the present invention;

FIG. 3e is another schematic diagram of viewing an enlarged picture according to an embodiment of the present invention;

FIG. 4 is a structural block diagram of a preview apparatus for searching for pictures by a mobile terminal according to Embodiment I of the present invention;

FIG. 5 is a structural block diagram of a preview apparatus for searching for pictures by a mobile terminal according to Embodiment II of the present invention;

FIG. 6 is a block diagram of a computing device for executing the preview method for searching for pictures by a mobile terminal according to the present invention; and

FIG. 7 is a memory cell for maintaining or carrying a program code for implementing the preview method for searching for pictures by a mobile terminal according to the present invention.

### DESCRIPTION OF THE EMBODIMENTS

The following will describe in more detail the exemplary embodiments of the

disclosure with reference to the accompanying drawings. Although the accompanying drawings display the exemplary embodiments of the disclosure, it should be understood that the disclosure may be implemented in various forms but not limited by the embodiments set forth herein. Rather, these embodiments are provided so that this disclosure will be understood thoroughly and completely and will fully convey the scope of the disclosure to those skilled in the art.

### Embodiment I

A preview method for searching for pictures by a mobile terminal provided by this embodiment of the present invention is introduced in detail.

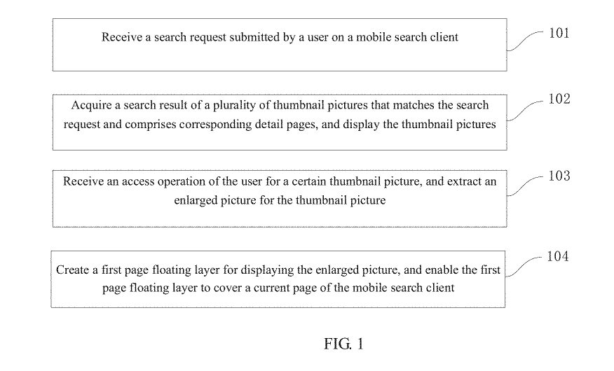

Referring to FIG. 1, a flowchart of steps of a preview method for searching for pictures by a mobile terminal according to Embodiment I of the present invention is illustrated.

Step 101: receiving a search request submitted by a user on a mobile search client.

The user may submit the search request through a web browser or a search client on the mobile terminal such as other search programs (for example, “Haosou” APP). For example, search is triggered by accessing a search engine website in the web browser or directly starting the search program and inputting a search keyword in a relevant input field or clicking a hot keyword.

Step 102: acquiring a search result of a plurality of thumbnail pictures that matches the search request and includes corresponding detail pages, and displaying the plurality of thumbnail pictures.

A corresponding search keyword is carried in the search request submitted by the user, a corresponding search result may be further acquired according to the search keyword. The search result corresponds to a detail page for displaying in more details and may include digest data corresponding to the detail page. In the embodiment of the present invention, the digest data of the search result are reasonably utilized, and a plurality of thumbnail pictures corresponding to the picture in the detail page are extracted and are displayed in front, so that a digest of the search result in the mobile search result page is in a multi-picture display form. The user may directly see whether there is a picture in the search result from a search result page, and may determine whether the picture is related to the search request. In this way, the user may select to view a picture meeting the user's searching requirements.

Step 103: receiving an access operation of the user for a certain thumbnail picture, and extracting an enlarged picture for the thumbnail picture.

In the embodiment of the present invention, a corresponding enlarged picture is provided for a thumbnail picture. The user may select to view a certain thumbnail picture, and may further extract the enlarged picture corresponding to the thumbnail picture after receiving the access operation of the user for the thumbnail picture.

Step 104: creating a first page floating layer for displaying the enlarged picture, and enabling the first page floating layer to cover a current page of the mobile search client.

After an enlarged picture is acquired, the enlarged picture is further displayed. Compared with a traditional scheme where a corresponding detail page is displayed after a search result is clicked, in the embodiment of the present invention, a detail page corresponding to a search result is not displayed after a thumbnail picture is clicked. Instead, a first page floating layer is created on a mobile search client to display the enlarged picture corresponding to the thumbnail picture, so that the user directly previews, on a current interface, pictures in the detail page. In this way, visual experience of the user for the search result is improved, user adhesiveness to the mobile search client is enhanced, operations for requesting pages from a server are reduced because it is unnecessary to display the corresponding detail page, traffic consumption of the mobile client is reduced, and loads on the mobile client and the server are reduced.

The enlarged picture is displayed on the current page of the search client, namely, displayed above the search result page in the form of suspending on the page floating layer of the current page.

Specifically, the first page floating layer may be implemented by employing an inline frame (iframe) for a current frame, wherein the iframe is a page element. When an iframe element is accessed, the page may create an iframe including another document to display the content in the iframe element. When the preview method is applied to the embodiment of the present invention, the thumbnail picture needing to be further enlarged may be putted in the iframe element of the search result page. When the thumbnail picture is accessed, the iframe element is triggered to generate an iframe to display the enlarged picture.

The preview method also may be implemented by a page mask layer technology. Specifically, two picture layers may be set on the page, wherein the top picture layer is a “masking layer”, and the bottom picture layer is referred to as a “masked layer”. Generally, when the page mask layer technology is used, only overlaps of the two picture layers can be displayed. That is, a place, where an object exists, in the masking layer is “transparent”, and the object in the masked layer may be seen. However, a place without the object is not transparent, and the object at a corresponding position in the masked layer cannot be seen. To implement a part of contents of a first page layer being masked by a second page layer, the display effect of the second page layer may be set to be non-transparent.

When the preview method is applied to the embodiment of the present invention, two DIV layers may be defined when a search result page is written. One DIV layer (correspondingly displaying the enlarged picture) needing to be masked is partly covered using the other DIV layer positioned on the previous DIV layer (correspondingly displaying the search result) needing to be masked. Styles of the DIV layer and the masking layer needing to be displayed are defined via a cascading style sheet (CSS), An up-down stereoscopic relation between the masking layer displayed on the top and the DIV layer displayed at the bottom in an overlapping sequence is controlled by displaying a z-index attribute of the element. A position where the second page layer of the first page floating layer covers the first page layer may be set according to the actual demands, which is not particularly limited in the present invention.

In the embodiment of the present invention, preferably, the first page floating layer is displayed, in full screen, on the mobile search client. The enlarged picture may be displayed in full screen, which may be larger than a picture displayed in the detail page, thereby facilitating the user to view the picture and improving a visual effect of the picture.

In the embodiment of the present invention, preferably, a plurality of the thumbnail pictures included in the search result are pictures displayed in first screen in the detail page, or thumbnail pictures respectively corresponding to a preset number of pictures top ranked in the detail page, or thumbnail pictures selected from the detail page according to needs and predesigned rules, which are not limited in the present invention.

In the embodiment of the present invention, preferably, the receiving an access operation of the user for a certain thumbnail picture, and extracting an enlarged picture for the thumbnail picture include:

Substep S11: receiving an access operation of the user for a thumbnail picture therein;

Substep S12: searching a link address of the enlarged picture corresponding to the accessed thumbnail picture; and

Substep S13: accessing the searched link address to download the enlarged picture corresponding to the accessed thumbnail picture.

After the access operation for the thumbnail picture is received, the link address of the enlarged picture corresponding to the thumbnail picture is further searched so that the corresponding enlarged picture is acquired according to the link address. In specific implementation, the link address may be acquired from the corresponding detail page.

In the embodiment of the present invention, preferably, the search result further includes a page title, a page site name and a page domain name of the detail page displaying the search result, and may further include other key information.

Correspondingly, the creating a first page floating layer for displaying the enlarged picture, and enabling the first page floating layer to cover a current page of the mobile search client include: creating the first page floating layer for displaying the enlarged picture, the page title, picture digest data, the page site name and the page domain name, and enabling the first page floating layer to cover the current page of the mobile search client.

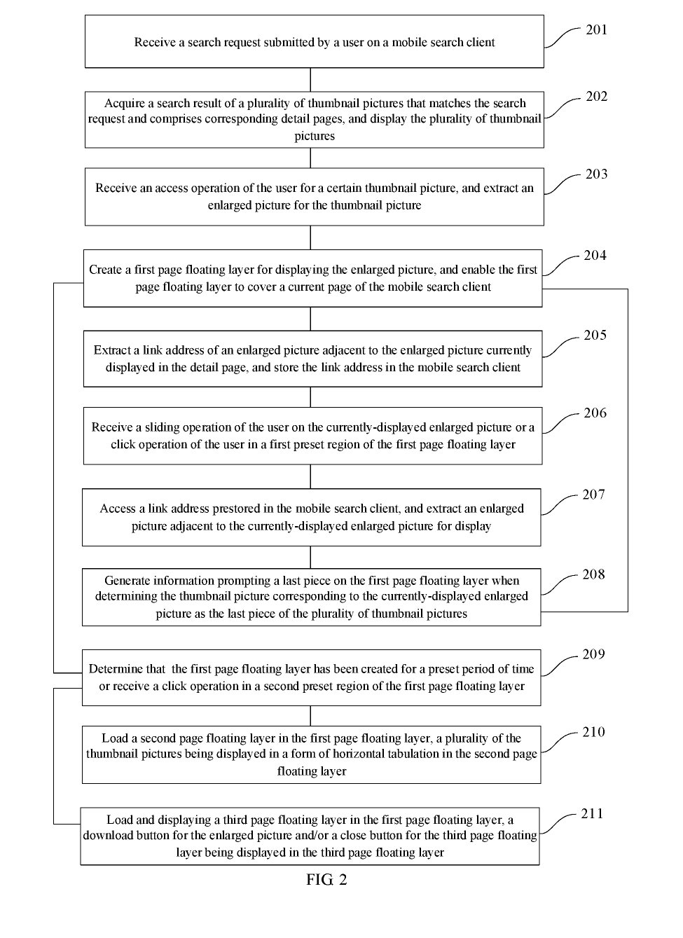

Referring to FIG. 2, a flowchart of steps of a preview method for searching for pictures by a mobile terminal according to Embodiment II of the present invention is illustrated.

Step 201: receiving a search request submitted by a user on a mobile search client.

Step 202: acquiring a search result of a plurality of thumbnail pictures that matches the search request and includes corresponding detail pages, and displaying the plurality of thumbnail pictures.

Step 203: receiving an access operation of the user for a certain thumbnail picture, and extracting an enlarged picture for the thumbnail picture.

Step 204: creating a first page floating layer for displaying the enlarged picture, and enabling the first page floating layer to cover a current page of the mobile search client.

Different from the previous embodiment, in this embodiment, after receiving an access operation of the user for the thumbnail picture and extracting an enlarged picture for the thumbnail picture, the link address of a next probably accessed enlarged picture may be extracted in advance. As shown in FIG. 2, Step 205 may be further included.

Step 205: extracting a link address of an enlarged picture adjacent to the enlarged picture currently displayed in the detail page, and storing the link address in the mobile search client.

In the embodiment of the present invention, after a thumbnail picture therein is accessed, a link address of an adjacent enlarged picture may be extracted in advance and stored in a mobile search client. The user may locally extract the link address to directly acquire the picture when the user needs to view a next picture. Compared with a scheme for temporarily extracting the link address, the picture can be more rapidly displayed.

In specific implementation, the corresponding enlarged picture may also be further extracted in advance according to the link address and stored in the mobile search client to more quickly leaf pictures through.

Step 206: receiving a sliding operation of the user on the currently-displayed enlarged picture or a click operation of the user in a first preset region of the first page floating layer.

The user may view a previous enlarged picture by sliding the current enlarged picture to the left or view a next enlarged picture by sliding the current enlarged picture to the right. The user also may view the previous enlarged picture or the next enlarged picture by clicking a preset region. For example, the user may view the previous enlarged picture by clicking the left side of the enlarged picture and view the next enlarged picture by clicking the right side of the enlarged picture, which is not particularly limited by the present invention.

Step 207: accessing a link address prestored in the mobile search client, and extracting an enlarged picture adjacent to the currently-displayed enlarged picture for display.

Further, a corresponding picture may be extracted and displayed according to the prestored link address.

Step 208: generating information prompting a last piece on the first page floating layer when determining the thumbnail picture corresponding to the currently-displayed enlarged picture as the last piece of the plurality of thumbnail pictures.

A special identifier may be added for the last picture, so that a prompt may be generated when viewing the picture, it is determined the picture is the last picture according to the identifier.

Step 209: determining that the first page floating layer has been created for a preset period of time or receiving a click operation in a second preset region of the first page floating layer.

Step 210: loading a second page floating layer in the first page floating layer, a plurality of the thumbnail pictures being displayed in a form of horizontal tabulation in the second page floating layer; and/or

Step 211: loading and displaying a third page floating layer in the first page floating layer, a download button for the enlarged picture and/or a close button for the third page floating layer being displayed in the third page floating layer.

Various operations may further be implemented on the first page floating layer. A second page floating layer may be generated on the first page floating layer, a plurality of thumbnail pictures are extracted from the second page floating layer and are displayed in a tabulation form. The pictures may also be leaf through by clicking the pictures in the tabulation. Further, a third page floating layer may also be generated on the first page floating layer, and a plurality of operation buttons are displayed on the third page floating layer, thereby facilitating user operation. For example, the enlarged picture may be downloaded by clicking a download button. Compared with a traditional manner of downloading pictures from the detail pages, not only operation is simple, but also the picture is larger and clearer. Alternatively, by clicking the close button, correspondingly the first page floating layer is closed directly to return to the search result page, so that the user may continue viewing other search results, which is more simple and rapid compared with the traditional manner in which after a detail page is viewed, it is necessary to quit to view another detail page.

In specific implementation, the second page floating layer and the third page floating layer may be two different floating layers or may be the same floating layer, which is not particularly limited by the present invention.

In the embodiment of the present invention, preferably, the extracting a link address of an enlarged picture adjacent to the enlarged picture currently displayed in the detail page, and storing the link address in the mobile search client may include:

extracting link addresses of enlarged pictures corresponding to other thumbnail pictures in the search result, and storing the link addresses in the mobile search client; or

extracting link addresses of two enlarged pictures before and after the enlarged picture displayed in the detail page, and storing the link addresses in the mobile search client.

In this embodiment, after a certain thumbnail picture is clicked, link addresses corresponding to enlarged pictures corresponding to other currently-displayed thumbnail pictures may further be extracted, or enlarged pictures respectively corresponding to two thumbnail pictures before and after the currently-displayed thumbnail picture may be extracted, that is, two enlarged pictures before and after the currently-displayed enlarged picture are displayed.

According to embodiments of the present invention, after receiving a search request submitted by a user on a mobile search client, a search result is acquired according to the search request, and thumbnail pictures of detail pages included in the search result are displayed. The user may directly see whether there is a picture in the search result from a search result page, and may determine whether the picture is related to the search request. In this way, the user may select to view a picture meeting the user's searching requirements. Further, after receiving an access operation of the user for a certain thumbnail picture, a detail page corresponding to the search result is not displayed. Instead, a first page floating layer is created on the mobile search client to display the enlarged picture corresponding to the thumbnail picture, so that the user directly previews, on a current interface, pictures in the detail page. In this way, visual experience of the user for the search result is improved, user adhesiveness to a mobile search client is enhanced, operations for requesting pages from a server are reduced because it is unnecessary to display the corresponding detail page, traffic consumption of the mobile client is reduced, and loads on the mobile client and the server are reduced.

In the embodiment of the present invention, after a thumbnail picture therein is accessed, a link address of an adjacent enlarged picture may be extracted in advance and stored in a mobile search client. The user may locally extract the link address to directly acquire the picture when the user needs to view a next picture. Compared with a scheme for temporarily extracting the link address, the picture can be more rapidly displayed.

It should be explained that, for a brief description, the foregoing method embodiments are described as a combination of a series of motions. However, those skilled in the art should know that the present invention is not limited by sequences of the motions described. This is because some steps may be performed by using other sequences or be performed simultaneously in accordance with the present invention. In addition, those skilled in the art should also learn that the embodiments described in the specification are preferred embodiments, and involved motions are not necessary for the present invention.

The preview effect for searching pictures by the mobile terminal in the embodiment of the present invention is illustrated through a specific example.

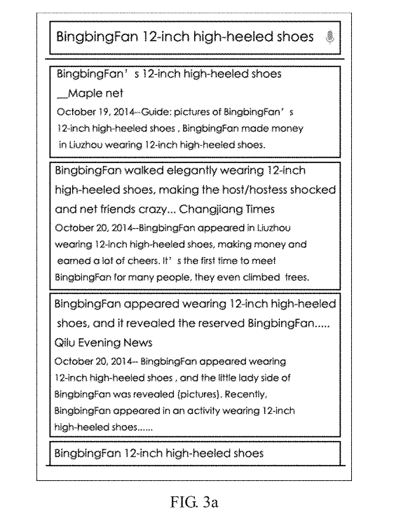

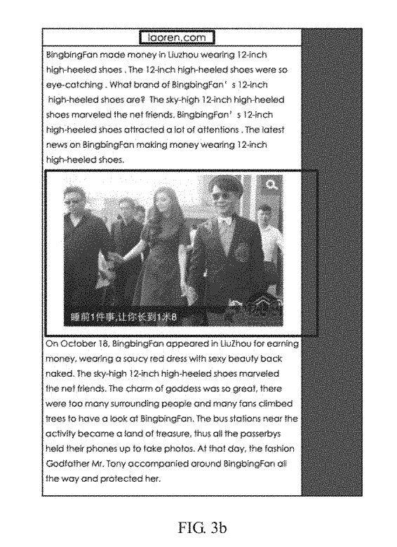

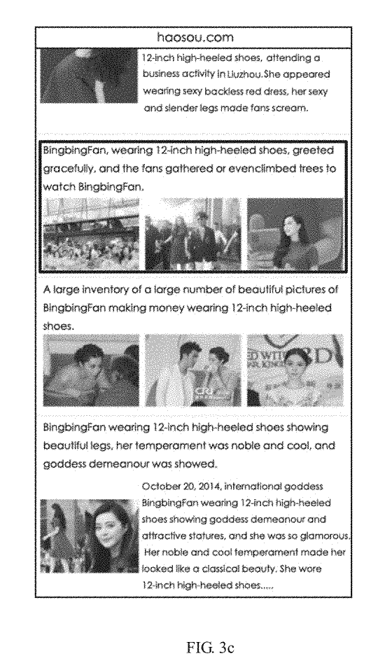

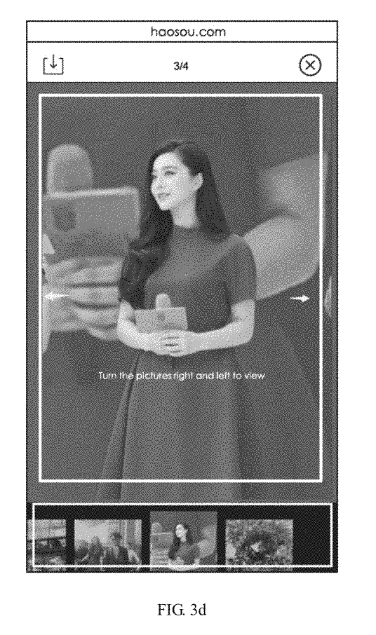

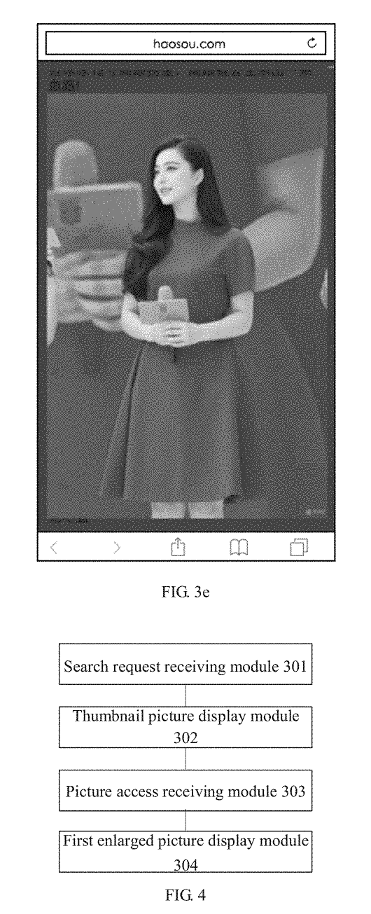

By taking the search keyword “Fan Bingbing's 12-inch high-heeled shoes” as an example, as shown in FIG. 3a, a schematic diagram of a search result in the background art is illustrated. The search result displays, in combination, a title, a text digest, and a detail page addresses. When a search result therein is clicked, the displayed detail page is as shown in FIG. 3b, words and pictures therein are displayed in combination. The pictures are smaller and thus cannot be viewed unless being enlarged.

As shown in FIG. 3c, a schematic diagram of a search result page in the embodiment of the present invention is illustrated, in which a search result is displayed in combination in form of titles, a plurality of thumbnail pictures, domain names and detail page addresses.

As shown in FIG. 3d, a schematic diagram of viewing an enlarged picture according to the embodiment of the present invention is illustrated. After a picture among a plurality of pictures of news on the search result page is clicked, a black transparent floating layer appears and is placed above the search result page to strongly display the clicked pictures in full screen. A download function, a close function and other picture horizontal tabulation respectively appear on the top and at the bottom after about 1-2 s, with the purpose of enabling the user to know there are other functions, or to invoke close, download and picture tabulations after clicking the enlarged pictures or the black floating layer when the user wants to close/download/view pictures thereafter. Next, the enlarged pictures may be viewed by sliding the screen to the left or right. When a last page is turned, a prompt of notifying the user that “the last page” is displayed. Furthermore, close, download and multi-picture functions are invoked.

As shown in FIG. 3e, another schematic diagram of viewing an enlarged picture according to the embodiment of the present invention is illustrated. The download, close and horizontal picture tabulations disappear after a preset period of time, not affecting the user experience.

### Embodiment III

A preview apparatus for searching for pictures by a mobile terminal provided by this embodiment of the present invention is introduced in detail.

Referring to FIG. 4, a structural block diagram of a preview apparatus for searching for pictures by a mobile terminal according to Embodiment I of the present invention is illustrated.

The apparatus may include:

a search request receiving module 301, configured to receive a search request submitted by a user on a mobile search client;

a thumbnail picture display module 302, configured to acquire a search result of a plurality of thumbnail pictures that matches the search request and includes corresponding detail pages, and display the plurality of thumbnail pictures;

a picture access receiving module 303, configured to receive an access operation of the user for a certain thumbnail picture, and extract an enlarged picture for the thumbnail picture; and

a first enlarged picture display module 304, configured to create a first page floating layer for displaying the enlarged picture, and enable the first page floating layer to cover a current page of the mobile search client.

In the embodiment of the present invention, preferably, the first page floating layer is displayed, in full screen, on the mobile search client.

In the embodiment of the present invention, preferably, a plurality of the thumbnail pictures included in the search result are thumbnail pictures respectively corresponding to a preset number of pictures top ranked or displayed in first screen in the detail page.

In the embodiment of the present invention, preferably, the picture access receiving module includes:

an operation receiving module, configured to receive an access operation of the user for a thumbnail picture therein;

an address searching module, configured to search a link address of the enlarged picture corresponding to the accessed thumbnail picture; and

a picture download module, configured to access the searched link address to download the enlarged picture corresponding to the accessed thumbnail picture.

In the embodiment of the present invention, preferably, the search result further includes a page title, a page site name and a page domain name of the detail page displaying the search result.

The first enlarged picture display module is specifically configured to create the first page floating layer for displaying the enlarged picture, the page title, picture digest data, the page site name and the page domain name, and enable the first page floating layer to cover a current page of the mobile search client.

According to embodiments of the present invention, after receiving a search request submitted by a user on a mobile search client, a search result is acquired according to the search request, and thumbnail pictures of detail pages included in the search result are displayed. The user may directly see whether there is a picture in the search result from a search result page, and may determine whether the picture is related to the search request. In this way, the user may select to view a picture meeting the user's searching requirements. Further, after receiving an access operation of the user for a certain thumbnail picture, a detail page corresponding to the search result is not displayed. Instead, a first page floating layer is created on the mobile search client to display the enlarged picture corresponding to the thumbnail picture, so that the user directly previews, on a current interface, pictures in the detail page. In this way, visual experience of the user for the search result is improved, user adhesiveness to a mobile search client is enhanced, operations for requesting pages from a server are reduced because it is unnecessary to display the corresponding detail page, traffic consumption of the mobile client is reduced, and loads on the mobile client and the server are reduced.

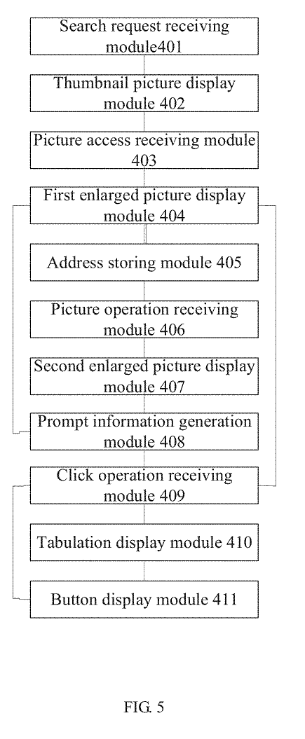

Referring to FIG. 5, a structural block diagram of a preview apparatus for searching for pictures by a mobile terminal according to Embodiment II of the present invention is illustrated.

The apparatus may include:

a search request receiving module 401, configured to receive a search request submitted by a user on a mobile search client;

a thumbnail picture display module 402, configured to acquire a search result of a plurality of thumbnail pictures that matches the search request and includes corresponding detail pages, and display the plurality of thumbnail pictures;

a picture access receiving module 403, configured to receive an access operation of the user for a certain thumbnail picture, and extract an enlarged picture for the thumbnail picture;

a first enlarged picture display module 404, configured to create a first page floating layer for displaying the enlarged picture, and enable the first page floating layer to cover a current page of the mobile search client;

an address storing module 405, configured to extract a link address of an enlarged picture adjacent to the enlarged picture currently displayed in the detail page, and store the link address in the mobile search client;

a picture operation receiving module 406, configured to receive a sliding operation of the user on the currently-displayed enlarged picture or a click operation of the user in a first preset region of the first page floating layer;

a second enlarged picture display module 407, configured to access a link address prestored in the mobile search client, and extract an enlarged picture adjacent to the currently-displayed enlarged picture for display;

a prompt information generation module 408, configured to generate information prompting a last piece on the first page floating layer when determining the thumbnail picture corresponding to the currently-displayed enlarged picture as the last piece of the plurality of thumbnail pictures;

a click operation receiving module 409, configured to, determine that the first page floating layer has been created for a preset period of time or receive a click operation in a second preset region of the first page floating layer;

a tabulation display module 410, configured to load a second page floating layer in the first page floating layer, a plurality of the thumbnail pictures being displayed in a form of horizontal tabulation in the second page floating layer; and/or

a button display module 411, configured to load and display a third page floating layer in the first page floating layer, a download button for the enlarged picture and/or a close button for the third page floating layer being displayed in the third page floating layer.

In the embodiment of the present invention, preferably, the address storing module is specifically configured to extract link addresses of enlarged pictures corresponding to other thumbnail pictures in the search result, and store the link addresses in the mobile search client; or

the address storing module is specifically configured to extract link addresses of two enlarged pictures before and after the enlarged picture displayed in the detail page, and store the link addresses in the mobile search client.

According to embodiments of the present invention, after receiving a search request submitted by a user on a mobile search client, a search result is acquired according to the search request, and thumbnail pictures of detail pages included in the search result are displayed. The user may directly see whether there is a picture in the search result from a search result page, and may determine whether the picture is related to the search request. In this way, the user may select to view a picture meeting the user's searching requirements. Further, after receiving an access operation of the user for a certain thumbnail picture, a detail page corresponding to the search result is not displayed. Instead, a first page floating layer is created on the mobile search client to display the enlarged picture corresponding to the thumbnail picture, so that the user directly previews, on a current interface, pictures in the detail page. In this way, visual experience of the user for the search result is improved, user adhesiveness to a mobile search client is enhanced, operations for requesting pages from a server are reduced because it is unnecessary to display the corresponding detail page, traffic consumption of the mobile client is reduced, and loads on the mobile client and the server are reduced.

In the embodiment of the present invention, the enlarged picture may be displayed in full screen, which may be larger than a picture displayed in the detail page, thereby facilitating the user to view the picture and improving a visual effect of the picture.

In the embodiment of the present invention, after a thumbnail picture therein is accessed, a link address of an adjacent enlarged picture may be extracted in advance and stored in a mobile search client. The user may locally extract the link address to directly acquire the picture when the user needs to view a next picture. Compared with a scheme for temporarily extracting the link address, the picture can be more rapidly displayed.

The embodiment of the preview apparatus for searching for pictures by a mobile terminal is basically similar to the above method embodiment, thusly the description is relatively simple, and the related part may be referred to the parts of the method embodiment.

The embodiments in the specification are described in a progressive manner. Each embodiment is focused on difference from other embodiments. And cross reference is available for identical or similar parts among different embodiments.

It is conceivable to those skilled in the art that arbitrary combination and application of various embodiments mentioned above may be feasible, and thus arbitrary combination of various embodiments mentioned above is an implementation scheme of the present invention, which is not expatiated one by one herein due to limitation of space.

Preview method and apparatus for searching for pictures by a mobile terminal herein are not inherently related to a particular computer, a virtual system or other equipment. Various general systems may also be used with the teaching based on the present invention. According to the above description, the required structure for constructing such a system having the solution of the present invention is obvious. In addition, the present invention is not directed to any particular programming language. It should be understood that a variety of programming languages can be used to implement the disclosed contents as described herein and above description to the particular programming language is to disclose the best inventive implementation mode.

Many details are discussed in the specification provided herein. However, it should be understood that the embodiments of the present invention can be implemented without these specific details. In some examples, the well-known methods, structures and technologies are not shown in detail so as to avoid an unclear understanding of the description.

Similarly, it should be understood that, in order to simplify the disclosure and to facilitate the understanding of one or more of various aspects thereof, in the above description of the exemplary embodiments of the present invention, various features of the present invention may sometimes be grouped together into a single embodiment, accompanying figure or description thereof. However, the method of this disclosure should not be constructed as follows: the present invention for which the protection is sought claims more features than those explicitly disclosed in each of claims. More specifically, as reflected in the following claims, the inventive aspect is in that the features therein are less than all features of a single embodiment as disclosed above. Therefore, claims following specific embodiments are definitely incorporated into the specific embodiments, wherein each of claims can be considered as a separate embodiment of the present invention.

It should be understood by those skilled in the art that modules of the device in the embodiments can be adaptively modified and arranged in one or more devices different from the embodiment. Modules, units or components in the embodiment can be combined into one module, unit or component, and also can be divided into more sub-modules, sub-units or sub-components. Except that at least some of features and/or processes or units are mutually exclusive, various combinations can be used to combine all the features disclosed in specification (including claims, abstract and accompanying figures) and all the processes or units of any methods or devices as disclosed herein. Unless otherwise definitely stated, each of features disclosed in specification (including claims, abstract and accompanying figures) may be taken place with an alternative feature having same, equivalent or similar purpose.

In addition, it should be understood by those skilled in the art, although some embodiments as discussed herein include some features included in other embodiment rather than other feature, combination of features in different embodiment means that the combination is within a scope of the present invention and forms the different embodiment. For example, in the claims, any one of the embodiments for which the protection is sought can be used in any combination manner.

Each of devices according to the embodiments of the present invention can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the parts in the preview apparatus for searching for pictures by a mobile terminal according to the embodiments of the present invention. The present invention may further be implemented as equipment or device program (for example, computer program and computer program product) for executing some or all of the methods as described herein. Such program for implementing the present invention may be stored in the computer readable medium, or have a form of one or more signals. Such a signal may be downloaded from the Internet websites, or be provided on a carrier signal, or provided in any other form.

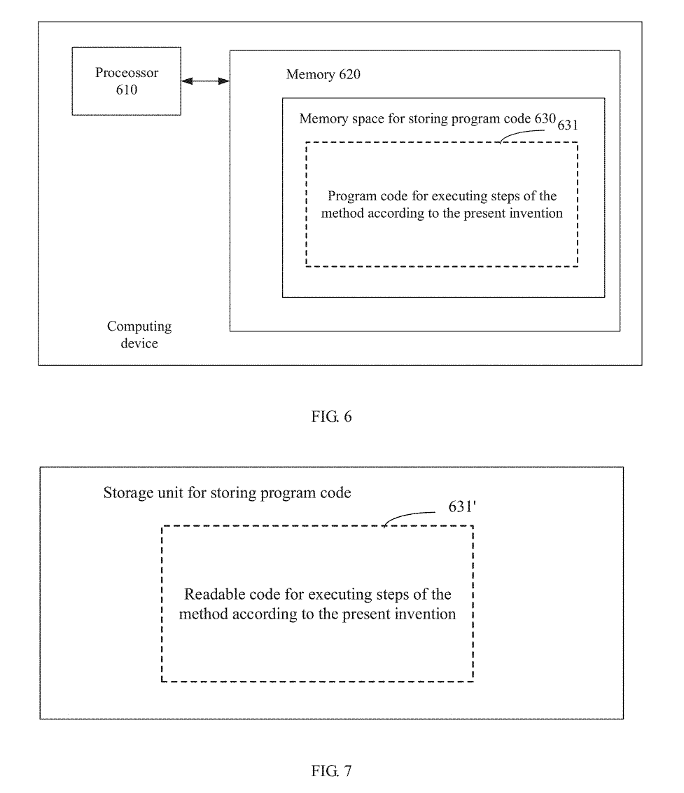

For example, FIG. 6 illustrates a computing device for executing the preview method for searching for pictures by a mobile terminal according to the present invention. Traditionally, the computing device includes a processor 610 and a program product or a readable medium in form of a memory 620. The memory 620 could be electronic memories such as flash memory, EEPROM (Electrically Erasable Programmable Read—Only Memory), EPROM or ROM. The memory 620 has a memory space 630 for executing program codes 631 of any steps in the above methods. For example, the memory space 630 for program codes may include respective program codes 631 for implementing the respective steps in the method as mentioned above. These program codes may be read from and/or be written into one or more program products. These program products include program code carriers such as memory card. These program products are usually the portable or stable memory cells as shown in reference FIG. 7. The memory cells may be provided with memory sections, memory spaces, etc., similar to the memory 620 of the computer device as shown in FIG. 6. The program codes may be compressed for example in an appropriate form. Usually, the memory cell includes readable codes 631′ which can be read for example by processors 610. When these codes are operated on the computing device, the computing device may execute respective steps in the method as described above.

It should be noted that the above-described embodiments are intended to illustrate but not to limit the present invention, and alternative embodiments can be devised by a person skilled in the art without departing from the scope of claims as appended. In the claims, no reference mark between round brackets shall impose restriction on the claims. The word “include” does not exclude a component or step not listed in the claims. The wording “a” or “an” in front of an element does not exclude the presence of a plurality of such elements. The present invention may be realized by way of hardware including a number of different components and by way of a suitably programmed computer. In the unit claim listing a plurality of devices, some of these devices may be embodied in the same hardware. The wordings “first”, “second”, and “third”, etc. do not denote any order. These wordings can be construed as naming.

1. A preview method for searching for pictures by a mobile terminal, comprising:
receiving a search request submitted by a user on a mobile search client;
acquiring a search result of a plurality of thumbnail pictures that matches the search request and includes corresponding detail pages, and displaying the plurality of thumbnail pictures;
receiving an access operation of the user for a certain thumbnail picture, and extracting an enlarged picture for the thumbnail picture; and
creating a first page floating layer for displaying the enlarged picture, and enabling the first page floating layer to cover a current page of the mobile search client.

2. (canceled)

3. The method according to claim 1, wherein the plurality of thumbnail pictures included in the search result are thumbnail pictures respectively corresponding to a preset number of pictures top ranked or displayed in first screen in the detail page.

4. The method according to claim 1, wherein the receiving an access operation of the user for a certain thumbnail picture, and extracting an enlarged picture for the thumbnail picture comprises:
receiving an access operation of the user for a thumbnail picture therein;
searching a link address of the enlarged picture corresponding to the accessed thumbnail picture; and
accessing the searched link address to download the enlarged picture corresponding to the accessed thumbnail picture.

5. The method according to claim 1, wherein the search result further comprises a page title, a page site name and a page domain name of the detail page displaying the search result; and
the creating a first page floating layer for displaying the enlarged picture, and enabling the first page floating layer to cover a current page of the mobile search client comprises: creating the first page floating layer for displaying the enlarged picture, the page title, picture digest data, the page site name and the page domain name, and enabling the first page floating layer to cover the current page of the mobile search client.

6. The method according to claim 1, wherein after the receiving an access operation of the user for the thumbnail picture, and extracting an enlarged picture for the thumbnail picture, the method further comprises:
extracting a link address of an enlarged picture adjacent to the enlarged picture currently displayed in the detail page, and storing the link address in the mobile search client.

7. The method according to claim 6, wherein the extracting a link address of an enlarged picture adjacent to the enlarged picture currently displayed in the detail page, and storing the link address in the mobile search client comprises:
extracting link addresses of enlarged pictures corresponding to other thumbnail pictures in the search result, and storing the link addresses in the mobile search client; or
extracting link addresses of two enlarged pictures before and after the enlarged picture displayed in the detail page, and storing the link addresses in the mobile search client.

8. The method according to claim 1, further comprising:
receiving a sliding operation of the user on the currently-displayed enlarged picture or a click operation of the user in a first preset region of the first page floating layer; and
accessing a link address prestored in the mobile search client, and extracting an enlarged picture adjacent to the currently-displayed enlarged picture for display.

9. The method according to claim 1, wherein after the receiving a sliding operation of the user on the currently-displayed enlarged picture or a click operation of the user in a first preset region of the first page floating layer, the method further comprises:
generating information prompting a last piece on the first page floating layer when determining the thumbnail picture corresponding to the currently-displayed enlarged picture as the last piece of the plurality of thumbnail pictures.

10. The method according to claim 1, further comprising:
determining that the first page floating layer has been created for a preset period of time or receiving a click operation in a second preset region of the first page floating layers;
loading a second page floating layer in the first page floating layer, a plurality of the thumbnail pictures being displayed in a form of horizontal tabulation in the second page floating layer; or
loading and displaying a third page floating layer in the first page floating layer, a download button for the enlarged picture or a close button for the third page floating layer being displayed in the third page floating layer.

11. An computing device comprising:
a memory having instructions stored thereon;
a processor configured to execute the instructions to perform operations for preview of searching for pictures by a mobile terminal, the operation comprising;
receiving a search request submitted by a user on a mobile search client;
acquring a search result of a plurality of thumbnail pictures that matches the search request and includes corresponding detail pages, and displaying the plurality of thumbnail pictures;
receiving an access operation of the user for a certain thumbnail picture, and extracting an enlarged picture for the thumbnail picture; and
creating a first page floating layer for displaying the enlarged picture, and enabling the first page floating layer to cover a current page of the mobile search client.

12. (canceled)

13. The computing device according to claim 11, wherein the plurality of thumbnail pictures included in the search result are thumbnail pictures respectively corresponding to a preset number of pictures top ranked or displayed in first screen in the detail page.

14. The computing device according to claim 11, wherein the operation of receiving an access operation of the user for a certain thumbnail picture, and extracting an enlarged picture for the thumbnail picture comprises:
receiving an access operation of the user for a thumbnail picture therein;
searching a link address of the enlarged picture corresponding to the accessed thumbnail picture; and
accessing the searched link address to download the enlarged picture corresponding to the accessed thumbnail picture.

15. The comprising device according to claim 11, wherein the search result further comprises a page title, a page site name and a page domain name of the detail page displaying the search result; and
the operation of creating a first page floating layer for displaying the enlarged picture, and enabling the first page floating layer to cover a current page of the mobile search client comprises creating the first page floating layer for displaying the enlarged picture, the page title, picture digest data, the page site name and the page domain name, and enabling the first page floating layer to cover a current page of the mobile search client.

16. The computing device according to claim 11, wherein the operations further comprise:
extracting a link address of an enlarged picture adjacent to the enlarged picture currently displayed in the detail page, and storing the link address in the mobile search client.

17. The computing device according to claim 16, wherein the operation of extracting a link address of an enlarged picture adjacent to the enlarged picture currently displayed in the detail page, and storing the link address in the mobile search client comprises extracting link addresses of enlarged pictures corresponding to other thumbnail pictures in the search result, and storing the link addresses in the mobile search client; or
extracting link addresses of two enlarged pictures before and after the enlarged picture displayed in the detail page, and storing the link addresses in the mobile search client.

18. The computing device according to claim 11, wherein the operations further comprise:
receiving a sliding operation of the user on the currently-displayed enlarged picture or a click operation of the user in a first preset region of the first page floating layer; and
accessing a link address prestored in the mobile search client, and extracting an enlarged picture adjacent to the currently-displayed enlarged picture for display.

19. The computing device according to claim 11, wherein the operations comprise:
generating information prompting a last piece on the first page floating layer when determining the thumbnail picture corresponding to the currently-displayed enlarged picture as the last piece of the plurality of thumbnail pictures.

20. The computing device according to claim 11, wherein the operations further comprise:
determining that the first page floating layer has been created for a preset period of time or receiving a click operation in a second preset region of the first page floating layer;
loading a second page floating layer in the first page floating layer, a plurality of the thumbnail pictures being displayed in a form of horizontal tabulation in the second page floating layer; or
loading and displaying a third page floating layer in the first page floating layer, a download button for the enlarged picture or a close button for the third page floating layer being displayed in the third page floating layer.

21. (canceled)

22. A non-transitory-computer-readable medium, having computer programs stored thereon that, when executed by one or more processors of a computing device, cause the computing device to perform operations for preview of searching for pictures by a mobile terminal, the operations comprising:
receiving a search request submitted by a user on a mobile search client;
acquiring a search result of a plurality of thumbnail pictures that matches the search request and includes corresponding detail pages, and displaying the plurality of thumbnail pictures,
receiving an access operation of the user for a certain thumbnail picture, and extracting an enlarged picture for the thumbnail picture; and
creating a first page floating layer for displaying the enlarged picture, and enabling the first page floating layer to cover a current page of the mobile search client.
